(19) United States
(12) Patent Application Publication
(10) Pub. No.: US 2003/0154178 A1
(43) Pub. Date: Aug. 14, 2003

(54) Method of automatically updating non-image data associated with a digital image

(75) Inventors: Dale F. McIntyre, Honeoye Falls, NY (US); Andrew T. Cooper, Fairport, NY (US)

Correspondence Address: Milton S. Sales, Patent Legal Staff, Eastman Kodak Company, 343 State Street, Rochester, NY, 14650-2201, US

(73) Assignee: Eastman Kodak Company

(21) Appl. No.: 10/071,590

(22) Filed: Feb. 8, 2002

(51) Int. Cl. G06F 7/00

(52) U.S. Cl. 707/1

(57) ABSTRACT

A software product and a method for automatically updating non-image data stored at a first storage location using a first image application. The non-image data being associated with a digital image of a user. The method includes providing new information with respect to the digital image in a second image application and automatically updating the non-image data at the first storage location with respect to the information.

### FIELD OF THE INVENTION

This invention is in the field of methods of capturing information related to digital images and, more particularly, it is in the field of methods of automatically updating the non-image data for a digital image with new information.

### BACKGROUND OF THE INVENTION

The advent of digital imaging technology has greatly expanded the photographic experience for photographers. Digital images may be captured directly using relatively inexpensive digital cameras or, alternatively, images captured originally on film may be digitized and provided to the photographer on various types of removable storage media. The amount of computer memory space available at a reasonable cost has also expanded, so that a very large number of digital images may now also be conveniently stored on the hard drive of the photographer's computer. The existence of inexpensive high-quality home inkjet printers and image software applications such as Adobe PhotoDeluxe™ or Microsoft PictureIt!™ allow consumers to crop or otherwise edit images, or to make and print a variety of products utilizing images including greeting cards, calendars and various types of photo collages. The growth of the Internet has also contributed to enriching the photographic experience providing, among other features, image fulfillment service centers such as Ofoto™ where digital images may be uploaded and shared with others in the form of electronic photo albums. Also available are a wide variety of image-bearing products including simple hardcopy prints, enlargements, T-shirts, mugs, mousepads, and even finished photo album pages, for example, album pages provided by Eastman Kodak's Picture Page™ product.

The digital photography industry has also recognized the value of capturing ancillary non-pictorial information to be stored in association with digital images and hereto after referred to as non-image data. This non-image data stored in association with the image data can include information regarding camera conditions at the time of exposure such as shutter speed, aperture, condition of the flash, and the like, or the nature of the illuminant, as well as other information regarding the time and/or date of capture and the subject matter in the photograph. File formats such as EXIF, JPEG2000 or generic XML, specify the architecture and data file structures for the storage of such non-image data with image data. Non-image data of this type is useful, for example, to provide higher quality rendering of images on screen or in hard copy prints, or to allow easy organization of images in a database.

Many of the software applications available for the creative use of digital images mentioned above for use at home or at a remote fulfillment site allow the user to add information to the images being utilized in the application in the form of explanatory captioning or titling regarding the subject matter of the image. Typically, such captioning or titling will provide information on at least a portion of the so-called “five W's”: i.e., who is in the image, what is included in the image, why was the image taken, where was the image taken, and when was it taken? In some instances, the added information regarding the images may be provided by a third party. For example, the on-line photoservice Ofoto™ allows a photo album to be posted and makes it possible for the photo album owner then to grant access to the photo album via the communication network to an interested third party. Then the third party has the opportunity to add comments to the posted photo album, thereby greatly enhancing the sharing experience. Added information from any of these sources would be potentially of great value in organizing images, but currently there remains a need for a simple way to easily and automatically add the type of information available in the captioning or titling process to the actual non-image data associated with digital images.

### SUMMARY OF THE INVENTION

In accordance with one aspect of the present invention there is provided a method for automatically updating non-image data stored at a first storage location using a first image application, the non-image data being associated with a digital image of a user, comprising the steps of:

providing new information with respect to the digital image in a second image application; and

automatically updating the non-image data at the first storage location with respect to the information.

In accordance with another aspect of the present invention there is provided a method for automatically updating non-image data stored at a first location, the information being associated with a digital image of a user, comprising the steps of:

providing at least one digital image of a user to a remote image server;

the user granting access to at least one third party to the at least one digital image stored at the remote image server;

the third party providing information with respect to the at least one digital image using an image application running at the remote site; and

automatically updating the non-image data with the information.

In accordance with yet another aspect of the present invention there is provided a method for updating non-image data stored at a first location, the information being associated with a digital image of a user, comprising steps of:

providing at least one digital image of a user to a remote image server;

the user granting access to at least one third party to the at least one digital image stored at the remote image server;

the third party providing information with respect to the at least one digital image in an image application running at the remote image server;

notifying the user of the existence of the information with respect to the at least one digital image; and

automatically updating the non-image data with the information if the user decides to do so.

In accordance with still another aspect of the present invention there is provided a method for updating non-image data associated with digital images of a user stored at a first storage location, comprising the steps of:

granting access to the digital images stored at the first location to at least one third party;

transferring at least one of the digital images from the first storage location to the third party's computer over a communication network;

the third party providing information with respect to the at least one digital image in an image application running on the third party's computer;

notifying the user over the communication network of the existence of the information with respect to the at least one digital image; and

updating the non-image data stored at the first storage location with the information if the user decides to do so.

In accordance with software application for working with a digital image stored at a first storage location having associated information provided in a designated format, the software application, when running on a computer, enabling the computer to carry out the steps of:

obtaining the stored digital image from a first storage location;

providing additional information with respect to the digital image; and

automatically sending the additional information to the first storage location in the designated format.

In accordance with still another aspect of the present invention there is provided a software application for receiving and translating new non-image data associated with a digital image, the non-image data provided by a second image application, the software application, when running on a computer, enabling the computer to carry out the steps of:

receiving the new non-image data associated with a digital image from the second image application over a communication network;

translating the non-image data to comply with a designated format, the designated format determined by a first image application for managing and organizing digital images; and

updating the non-image data associated with the digital image stored at the first storage location with the new non-image data.

The above, and other objects, advantages and novel features of the present invention will become more apparent from the accompanying detailed description thereof when considered in conjunction with the following drawings.

### BRIEF DESCRIPTION OF THE DRAWINGS

In the detailed description of the preferred embodiments of the invention presented below, reference is made to the accompanying drawings in which:

FIG. 1 is a block diagram of a system made in accordance with the present invention;

FIG. 2 is a flow chart illustrating the steps in the operation of an embodiment of the present invention;

FIG. 3 is a flow chart illustrating the steps in the operation of an alternative embodiment of the present invention;

FIG. 4 is a flow chart illustrating the steps in the operation of an alternative embodiment of the present invention;

FIG. 5 is a flow chart illustrating the steps in the operation of an alternative embodiment of the present invention; and

FIG. 6 is a flow chart illustrating the steps in the operation of an alternative embodiment of the present invention.

### DETAILED DESCRIPTION OF THE INVENTION

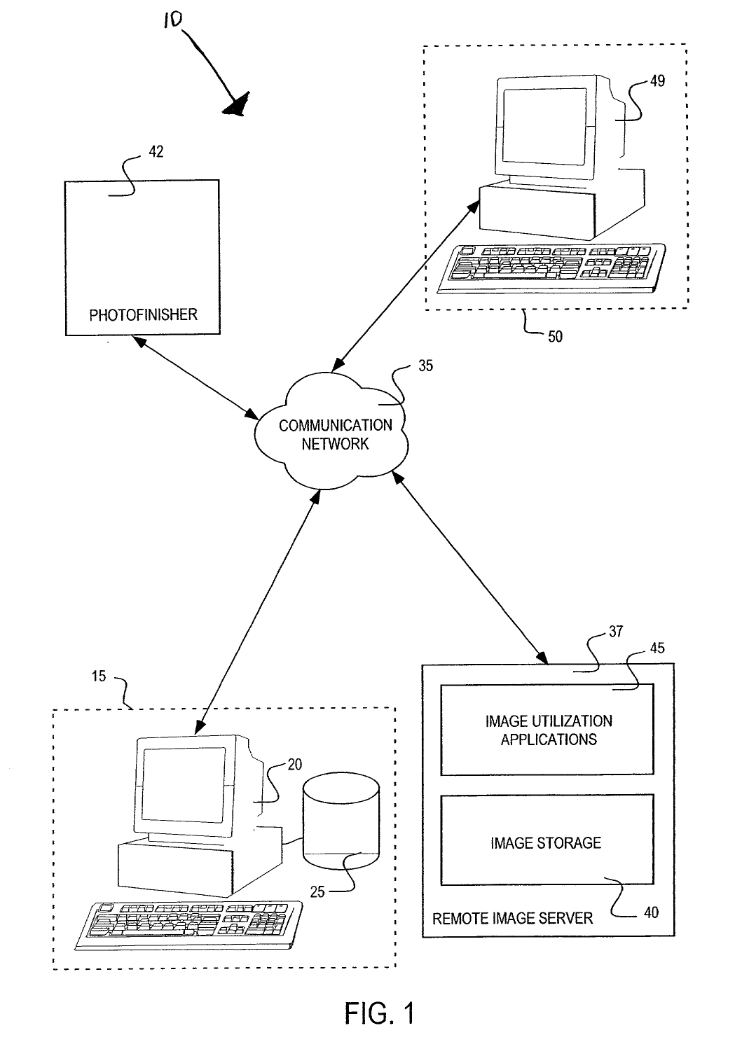

Referring first to FIG. 1, there is shown a system 10 useful for illustrating the operation of the present invention. The system 10 comprises a primary image storage location 15 which typically may be the personal computer 20 of a user, but may also be any electronic archive of digital images stored for any purpose. Associated with this primary storage location 15, is image storage facility 25. While the storage facility 25 is shown in FIG. 1 as a separate device such as a large capacity hard drive or “juke box” connected to the computer 20, image storage at the primary storage location 15 may simply be storage space on the hard-drive memory (not shown) of the computer 20. Computer 20 runs software such as an image management and organization application, referred to as first image application, which has a designated format of image storage for both digital images and associated non-image data. Computer 20 is also provided with appropriate communications hardware and software, as is well known in the art, for allowing communication with third parties over a communication network 35 such as the Internet. Also shown in FIG. 1 is a remote image server 37 accessible by the computer 20 via communication network 35. The remote image server 37 is located at an on-line photofinishing service such as Ofoto™ Inc. and comprises, among other elements, an image storage facility 40, and one or more image utilization applications 45 referred to as second image applications which may be accessed by users to carry out various functions such as the creation and editing of an on-line album or the specification and ordering of various image-bearing products such as prints, album pages, T-shirts, mugs, mouse-pads, and the like. A third party user 50 may also connect via the communication network 35 to remote image server 37 and access images there, if prior access to these images has been granted by the owner of the images. Although not shown in FIG. 1, it should be understood that various image utilization applications similar to those running on the remote image server 37, can also be installed on computer 20 at the primary storage location 15, or on the computer of the third party user 50 for use locally at those sites.

The digital images stored at the primary storage location 15 of FIG. 1 have associated with them non-image data commonly known as metadata, which may be embedded in the digital image files or may be associated with the image files in a database specific to image management application software resident on the user computer 20. Non-image data typically contains information pertinent to the images such as information regarding camera conditions at the time of exposure like shutter speed, lens aperture, condition of the flash, and the like, or the nature of the illuminant, as well as other information regarding the time and/or date of capture of the image or the subject matter of the image. A number of file format structures and data architectures have been described for the storage of such non-image data in association with image data. Examples include JPEG2000, XML, and EXIF formats which are commonly known in the art. Image management application software, such as Image Expert 2000™, offered by Sierra Imaging, creates a database to track non-image data entered automatically by the camera or manually by the user and stored in a designated format specific to the Image Expert 2000™ application software. In this manner, Image Expert 2000™ is a primary or first application responsible for managing and organizing digital images with associated non-image data. Such non-image data can be useful in many ways but is especially useful in enabling the easy organization of images in a database for later retrieval. Images can be organized by non-image data categories such as time or date of capture, location of capture, subject matter, etc. The organization of images may even be automated through the use of non-image data. For example, commonly assigned, co-pending U.S. patent application Ser. No. 09/199,639 by Shaffer, et al., discloses a method of creating a self-organizing photo album utilizing, among other elements, image metadata to automatically arrange images into a photo album according to various predetermined categories and criteria.

Many of the image utilization applications 45 running on the remote image server 37 in system 10 make provisions for the addition of descriptive information about the images being utilized. For example, the image utilization application used for ordering a hard copy print of an image allows the addition of a caption, which is added to the image when it is printed. Typically, captions added in this manner have not been retained with the original image after the image has been printed. An example of such an image application is the OfotoNow V3.0™ provided by Ofoto Inc. However, in the present invention, captions are stored in a temporary file and automatically added later to the non-image data of the original image being printed. In certain image utilization applications, captions may be added which relate to a group of images. For example, when a photo album page is specified for printing using, for example, Eastman Kodak Company's Memory Album Software™, it is possible to add a feature such as a title to a particular page identifying it, for example as “Vacation 2001”, or “What a Fishing Trip That Was!”, or some other information relating to the “five Ws” content of the images, as discussed previously. It should be noted that a photo album page may contain more than one group of images and therefore, features such as titles can be applied to individual groups within a page. According to the present invention, the features such as titles added to groups of images or album pages are saved and later used to automatically update the non-image data of all the images included in the specific page layout. Comments may also be added to collections or groups of images by a third party. For example, when a photo album (group of images) is uploaded from the image storage facility 25 at the primary storage location 15 (see FIG. 1) to a photo sharing website, as illustrated by remote image server 37, the owner of the photo album may then grant access to the photo album to a third party user 50, such as a family member or friend. As offered by the Ofoto™ website, third party users 50 have the opportunity to add comments to the photo album they are viewing such as for example, “What fun we had!”, or “We're all still looking young, aren't we?”. According to the present invention, these comments are saved along with information with respect to who made the comments, and the photo album owner at the primary storage location 15 is then notified of the existence of the comments. The photo album owner is then provided an opportunity to download the comments and have them automatically added to the non-image data of the appropriate images stored in the primary storage location 15.

Also shown in FIG. 1 is photofinisher 42 who receives film from a user, processes and digitizes the film, and loads the film into an account previously established by the user. An example of such a photofinisher is Ofoto Inc. who provides mailing envelopes for users with established accounts. Digital images are then available for producing image products. Other well known photofinishers such as the Kodak Picture Center™ at CVS.com do not require an established account. Instead, a claim check is added to the print packaging which provides the location and access codes for accessing and utilizing the resulting digital images.

In order to more clearly describe the present invention, the detailed operation of several embodiments will now be described.

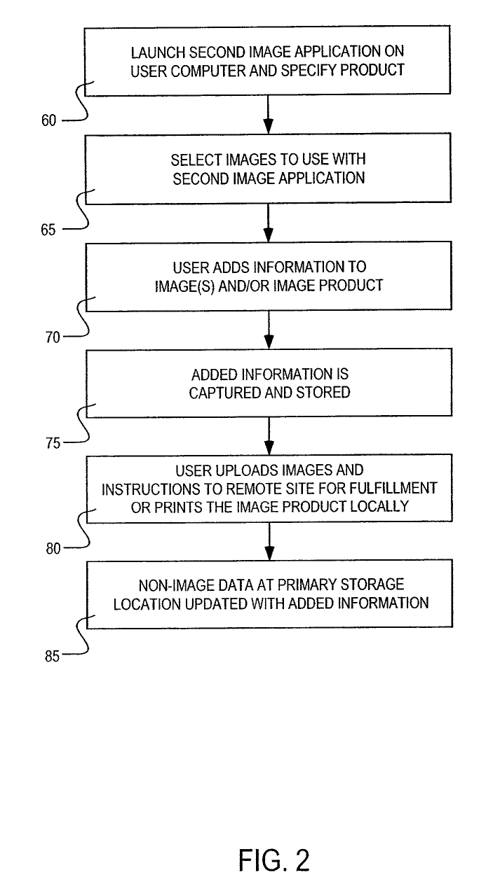

FIG. 2 shows the steps that are carried out in the first such embodiment where a user specifies an image product on computer 20 in order to print it locally or request fulfillment from a remote image server 37. Beginning with step 60, the user launches a second image utilization application on the user's computer 20 and if necessary, further specifies an image product that he desires to produce. As described earlier, the primary storage location 15 for images can comprise the hard drive of the user's computer 20, or an image storage facility 25 connected to the user's computer such as an auxiliary hard drive or some other rewritable memory disk “juke box.” In step 65, a user selects at least one image from the primary storage location 15 for use with the application. Examples of image applications which are useful with the present invention include software such as Adobe PhotoDeluxe™ where an image may be cropped or otherwise compiled with borders and special effects including text captions for specific products, or Microsoft Picture It!™ where a photocollage is specified by adding images selected to a predefined template or background. In step 70, the user adds information to the image or image product. In the case of a single print, this added information can be a descriptive caption or title which relates to the content of the image. In the case of a photocollage, the added information may be an overall title or caption descriptive of the photocollage. Next, in step 75, the added information is captured and stored in a temporary memory location or separate data file along with the identification to which image or images the information refers. In step 80, the user uploads the edited image or specified photocollage to a remote fulfillment site for printing, or where possible, prints the product locally. Finally, in step 85, the non-image data associated with the images stored in the primary storage location are automatically updated with the information stored in step 75. If the image format contains embedded data, then the original image file is updated with the new information. If the image format does not contain embedded data, then the application updates the database associated image management application software preferred by the user.

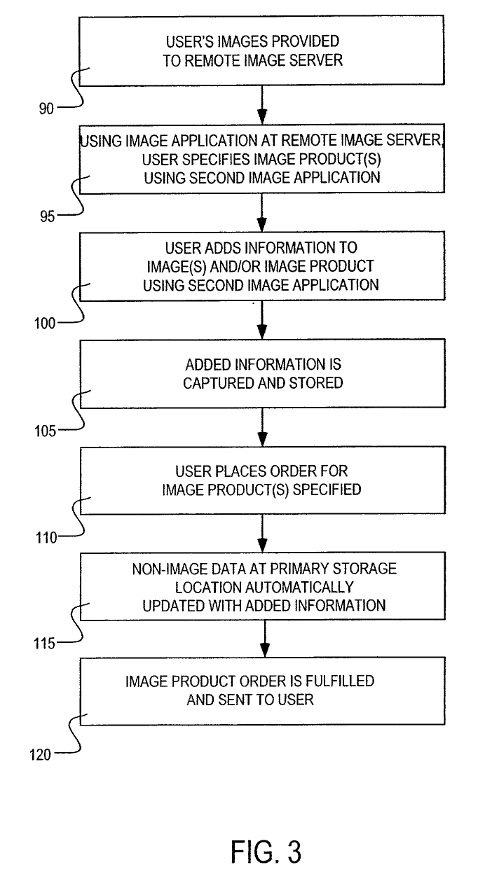

FIG. 3 illustrates the operation of another embodiment of the present invention where a user specifies an image product using an image application running on a remote image server 37. In first step 90, a user's images are provided to remote image server 37 by uploading copies of the original images. Images may be provided to remote image server 37 by the user uploading copies of the original images from a local computer 20, or from a kiosk using a communications channel such as the communication network 35. Alternatively, a user may submit film to photofinisher 42 who develops the film, scans it electronically, and then forwards the resulting digital image files to the user's account located at remote image server 37. As is typical in the art, the user would login at remote image server 37 for security purposes with a username and password. After logging on and accessing an image application running on the remote image server 37, the user specifies an image product in step 95 using at least a selection of the images provided in step 90. By way of example, but not limited to, the image applications available on the remote site may range from a simple application to specify a print, to more complex applications for specifying and ordering gifts such as a photo T-shirt, mug, mouse pad or an application to create an album page. Next, in step 100, the user adds information to the image product specified in step 95. As described before, the information added in step 100 may comprise a caption added to a single image or to a mug or T-shirt, or may be a title applied to an album page or other photocollage product. In step 105, the information added in step 100 is stored in a separate file at the primary storage location 15. Next, in step 110, the user places an order for the image product specified in step 95. In step 115, the added information stored in step 105 is used to automatically update the appropriate non-image data associated with the images stored at the primary storage location 15. At step 120, the image product order is fulfilled and sent to the user.

To automatically update the appropriate non-image data associated with the original images stored at the primary storage location 15, the remote image server 37 can initiate a Hypertext Transfer Protocol (http) text transfer to the user's computer 20 in which an Extensible Markup Language (XML) file is transferred that includes information such as original filename, storage location, and the added non-image data information to update. The XML file can be acted upon without user intervention by executable code associated with Internet browsers known in the art as plug-ins or it can be directed at a thin client software application that receives, translates, and updates the non-image data stored at the first storage location 15 with new information provided by the remote image server over the communication network. The browser plug-in or software application can determine the designated format of the non-image data by reviewing the file associations maintained by the operating system of computer 20 with respect to the first image application, which is used to manage or organize digital images. In another embodiment, the remote image server 37 can be aware of the non-image data designated format by requiring the user to set a preference for a specific first image application software.

If the original images are stored at remote image server 37 as a result of film processing and digitization, updating of non-image data is executed directly at the remote image server 37 whether embedded or databased. At a future point in time, a user may download the digital images to the computer 20 in which case the appropriate non-image data is transferred at the same time in the designated format and the original images become that images stored at the user's computer 20 or the image storage facility 25.

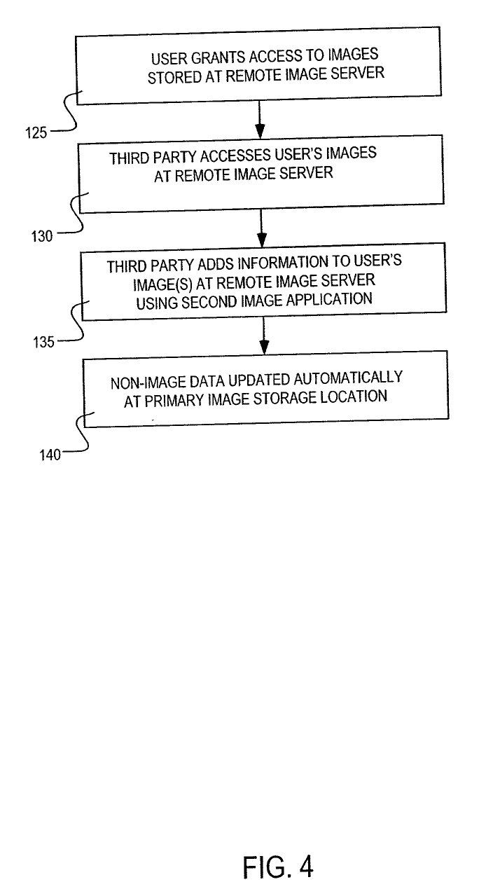

FIG. 4 shows the steps in the operation of yet another embodiment of the present invention where information provided by a third party user 50 is added to the appropriate non-image data associated the user's images. In the first step 125, a user grants access to a third party user 50 to the user's images stored in an account on remote image server 37. Access may be granted either by the user notifying the remote site administrator (not shown) that the third party user 50 is authorized and the remote site administrator, in turn, notifies the third party user 50 that they are authorized and provides an electronic address where the images can be viewed. As an alternative means of notification, the user may send an email directly to the third party user 50 giving them an electronic address for accessing the images at the remote image server 37. In step 130, the third party user 50 accesses the user's images at the remote site. After accessing the images in step 135, the third party user 50 adds information to the user's images while using an image application and the information is saved in a separate data file. Examples of the use of an image application by a third party user 50 to add information include, but are not limited to, third party user 50 adding comments to the user's on-line photo album or a third party user 50 adding a caption to an image and ordering a reprint of the image with the caption. Finally, in step 140, the non-image data associated with the user's original images are automatically updated with the information from step 135 in a manner similar to that described with respect to FIG. 3.

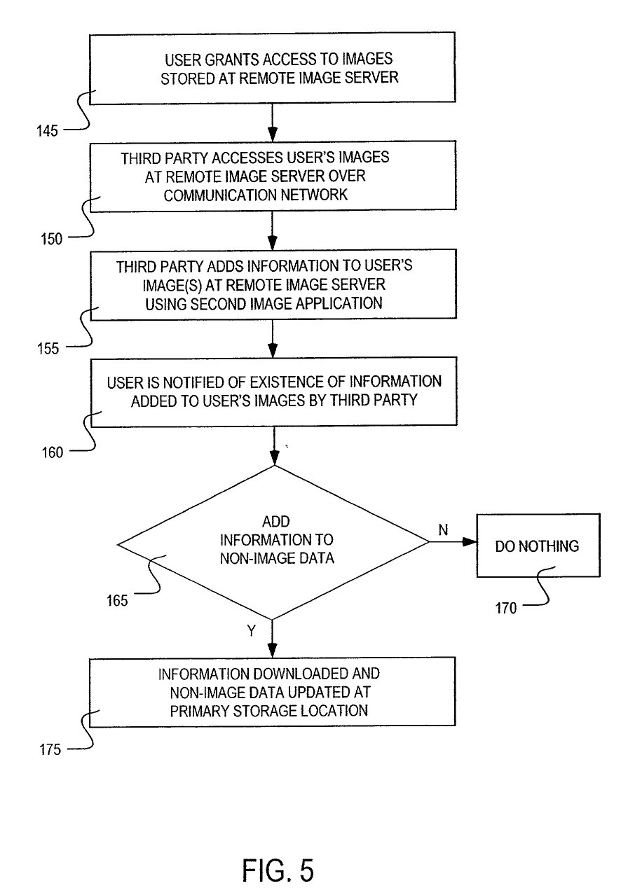

FIG. 5 describes a variation on the embodiment of FIG. 4 of the present invention, wherein the user is given a choice of whether or not to use the information provided by the third party user 50 to update his non-image data associated with original image files. Referring now to FIG. 5, steps 145, 150, and 155 are similar to steps 125, 130, and 135 of FIG. 4. Once the third party user 50 has provided information to a user's images, and the information has been saved, the user is then notified in step 160 of the existence of the information. Notification could be provided at the time the user logs on to his account at the remote image server 37, or a separate email notification could be sent to the user automatically whenever new information is available. In step 165, the user decides whether or not to add the new information to the appropriate non-image data associated with the user's images. If a “no” decision is made, the non-image data is deleted in step 170. If a “yes” decision is made, the non-image data associated with the user's images is updated in step 175 at the primary storage location 15.

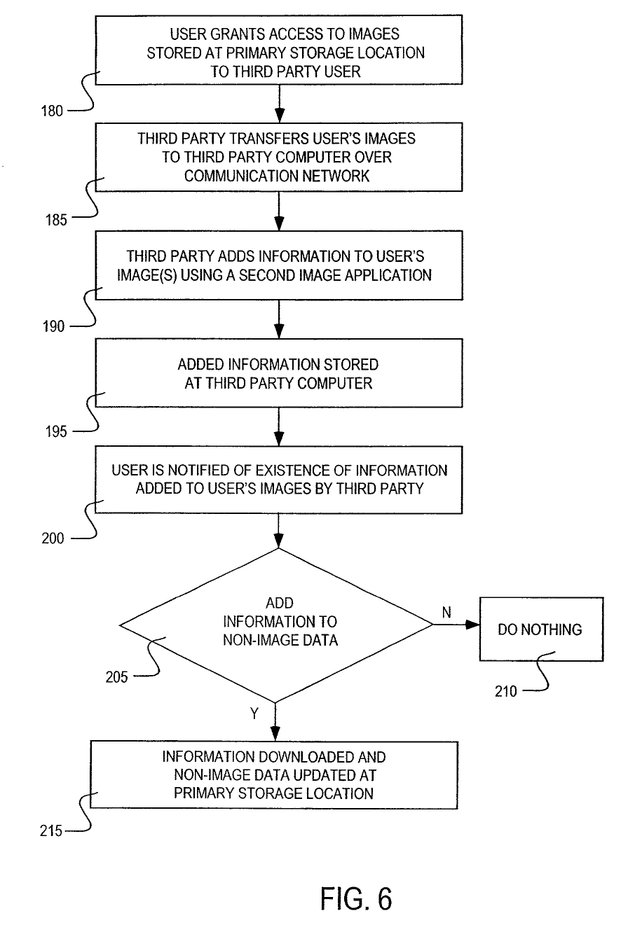

FIG. 6 depicts still another embodiment of the present invention where non-image data associated with a user's images stored at primary storage location 15 may be updated with information provided by a third party user 50 operating in a peer-to-peer sharing network such as popularized by Napster Inc. In step 180, the user grants access to images stored at the primary storage location 15 to a third party user 50. In step 185, the third party user 50 accesses images from the primary storage location 15 and transfers them to a third party computer 49 belonging to the third party user 50. Using an image application running on the third party computer 49, the third party user 50 adds information to the user's images (step 190), and the added information is stored in step 195 in association with the user's image at the third party computer 49. In step 200, the user is informed by an automatic email or instant message type notification of the existence of the added information. It will be understood that various forms of messaging including Instant Messaging™ offered by America Online Inc. can easily provide this functionality. In step 205, the user is offered the choice to download the new information to the primary storage location 15. If the decision to download is a “no”, then no action is taken as the added information is maintained by the third party in step 210. If the decision to download is “yes”, the information is downloaded in step 215 to the primary storage location 15 and the appropriate non-image data is automatically updated. Transfers using http protocol can be used for this updating process or a protocol specific to the peer-to-peer system can be used.

The invention has been described in detail with particular reference to certain preferred embodiments thereof, but it will be understood that variations and modifications can be effected within the scope of the invention.

### Parts List

10 system

15 primary storage location

20 personal computer

25 communication network

37 remote image facility

40 image storage facility

42 photofinisher

45 image utilization applications

49 third party computer

50 third party user

60 step

65 step

70 step

75 step

80 step

85 step

90 step

95 step

100 step

105 step

110 step

115 step

120 step

125 step

130 step

135 step

140 step

145 step

150 step

155 step

160 step

165 step

170 step

175 step

180 step

185 step

190 step

195 step

200 step

205 step

210 step

215 step

What is claimed is:

1. A method for automatically updating non-image data stored at a first storage location using a first image application, said non-image data being associated with a digital image of a user, comprising the steps of:
providing new information with respect to said digital image in a second image application; and
automatically updating said non-image data at said first storage location with respect to said information.

2. The method of claim 1 wherein said second image application further comprises an application for the production of an image product.

3. The method of claim 1 wherein said second image application runs on a computer which is associated with said first storage location.

4. The method of claim 1 wherein said non-image data and said digital image are stored at said first storage location.

5. The method of claim 3 wherein said non-image data is contained within said digital image.

6. The method of claim 1 wherein said provided information is used to update said non-image data associated with a group of said digital images of a user.

7. The method of claim 6 wherein said group of said digital images comprises an album page and said provided non-image information is provided with respect to a feature of the album page.

8. A method for automatically updating non-image data stored at a first location, said information being associated with a digital image of a user, comprising steps of:
providing at least one digital image of a user to a remote image server;
said user granting access to at least one third party to said at least one digital image stored at said remote image server;
said third party providing information with respect to said at least one digital image using an image application running at said remote site; and
automatically updating said non-image data with said information.

9. The method according to claim 8 wherein the step of said third party providing information with respect to said at least one said digital image further comprises providing comments with respect to a photo album stored at said remote site.

10. A method for updating non-image data stored at a first location, said information being associated with a digital image of a user, comprising steps of:
providing at least one digital image of a user to a remote image server;
said user granting access to at least one third party to said at least one digital image stored at said remote image server;
said third party providing information with respect to said at least one digital image in an image application running at said remote image server;
notifying said user of the existence of said information with respect to said at least one digital image; and
automatically updating said non-image data with said information if said user decides to do so.

11. A method for updating non-image data associated with digital images of a user stored at a first storage location, comprising the steps of:
granting access to said digital images stored at said first location to at least one third party;
transferring at least one of said digital images from said first storage location to said third party's computer over a communication network;
said third party providing information with respect to said at least one digital image in an image application running on said third party's computer;
notifying said user over said communication network of the existence of said information with respect to said at least one digital image; and
updating said non-image data stored at said first storage location with said information if said user decides to do so.

12. A software application for working with a digital image stored at a first storage location having associated information provided in a designated format, said software application, when running on a computer, enabling said computer to carry out the steps of:
obtaining said stored digital image from a first storage location;
providing additional information with respect to said digital image; and
automatically sending said additional information to said first storage location in said designated format.

13. A software application for receiving and translating new non-image data associated with a digital image, said non-image data provided by a second image application, said software application, when running on a computer, enabling said computer to carry out the steps of:
receiving said new non-image data associated with a digital image from said second image application over a communication network;
translating said non-image data to comply with a designated format, said designated format determined by a first image application for managing and organizing digital images; and
updating said non-image data associated with said digital image stored at said first storage location with said new non-image data.
